(19) United States
(12) Patent Application Publication
(10) Pub. No.: US 2023/0054707 A1
(43) Pub. Date: Feb. 23, 2023

(54) OPTICAL ELEMENT, PRISM WITH AN OPTICAL ELEMENT AND IMAGING OPTICAL SYSTEM WITH A PRISM AND AN OPTICAL ELEMENT

(71) Applicant: Nextlens Switzerland AG, Dietikon (CH)

(72) Inventors: Johannes Haase, Wädenswill (CH); Stephan Smolka, Dietikon (CH); David Andreas Niederer, Küttingen (CH); Frank Bose, Dietikon (CH)

(73) Assignee: Nextlens Switzerland AG, Dietikon (CH)

(21) Appl. No.: 17/820,250

(22) Filed: Aug. 17, 2022

(30) Foreign Application Priority Data
Aug. 17, 2021 (DE) 10 2021 121 389.4

(51) Int. Cl. G02B 7/18; G02B 27/09

(52) U.S. Cl. CPC G02B 7/1805; G02B 27/0972; G02B 13/0065

(57) ABSTRACT

Optical element (1) comprising a sealed volume (15), a first window (11), a second window (12) and a membrane (13), wherein the membrane (13) encloses the sealed volume (15) in lateral directions and the membrane (13) encloses the sealed volume (15) in directions perpendicular to lateral directions, or the first window (11) and the second window (12) enclose the sealed volume (15) in directions perpendicular to lateral directions, wherein the sealed volume (15) is deformable by tilting the first window (11) with respect to the second window (12), wherein the first window (11) and the second window (12) being spaced apart by a solid structure (14), and the solid structure (14) is arranged to guide a motion of the first window (11) with respect to the second window (12), so that a pressure in the sealed volume (15) is constant.

### CROSS-REFERENCE TO RELATED APPLICATIONS

This application claims priority to German patent application No. 10 2021 121 389.4, filed on Aug. 17, 2021.

### FIELD

The optical element described here and in the following is an optical element transparent to visible light and in particular suitable for a prism of an imaging optical system of a cell phone.

### BACKGROUND

The present optical element makes use of the idea to prevent damage of the windows or the membrane when applying a force to the optical element by guiding a relative motion of the first and second window with respect to each other.

In conventional optical elements a maximum pressure within the liquid volume is limited by limiting the maximum relative deflection of the first window with respect to the second window by means of hard stops. However, the hard stops do not maintain the pressure constant. Thus, acceleration forces still result in an increase of the pressure in the liquid volume. Furthermore, the hard stops limit the maximum tilt of the first and second window with respect to each other, which is disadvantageous for the intended operation of the optical element.

Advantageously, the solid structure of the present optical element guides the movement of the first window with respect the second window or vice versa when a force is applied to the optical element. In particular, the solid structure prevents a translation of the first window with respect to the second window along the optical axis. In particular, the solid structure does not limit maximum tilt of the windows with respect to each other. Thus, a risk of a damage of the membrane and/or the first or window is due to acceleration forces is reduced.

### SUMMARY

The optical element comprises a sealed volume, which is completely enclosed by solids in a fluid-tight manner. The optical element comprises a first window and a second window. In particular, the first window and the second window form optical surfaces of the optical element. For example, light interacting with the optical element in an intended manner is refracted at said optical surfaces. The first and the second widow may comprise glass, acrylic or fluorite. In particular, the material of the first window and the second window may be different. The optical element comprises a membrane, which is a thin, elastic solid to be able to enclose a fluid. In particular, the membrane and the first window and the second window comprise a material which is transparent for electromagnetic radiation in the visible wavelength range.

The membrane encloses the sealed volume in lateral directions. Here and in the following, lateral directions are directions which do not pass either the first window or the second window. Here and in the following, it is assumed that an optical axis extends perpendicular to the main extension planes of the first and the second window in an undeflected state. In particular, in a tuning state of the optical element where the first window and the second window extend parallel with respect to each other, the optical axis extends perpendicular to the main extension planes of the first and the second window and the lateral directions extend perpendicular with respect to the optical axis. Along the optical axis, the sealed volume is delimited by the first window and the second window. Alternatively, the membrane encloses the sealed volume in directions perpendicular to lateral directions. According to this alternative, the membrane is arranged between the sealed volume and the first window, and the membrane is arranged between the sealed volume and the second window. In particular, the membrane encapsulates the sealed volume completely on all sides.

The sealed volume is deformable. In particular, the sealed volumen comprises a fluid material, wherein a shape of the fluid material may be altered when deforming the sealed volume. In particular, the sealed volumen is deformable by tilting the first window with respect to the second window. The sealed volume may be deformable by tilting the second window with respect to the first window or by tilting the first window and the second window windows.

The first window and the second window are spaced apart from each other, wherein a solid structure is arranged between the first window and the second window. The solid structure is arranged to guide a motion of the first window and the second window with respect to each other. In particular, the solid structure guides the first window with respect to the second window or the second window with respect to the first window. In particular, the solid structure is arranged to guide a motion of the first window and the second window, in case both the first and the second window are tiltable. The solid structure comprises a rigid, preferably inelastic, material to keep the first window and the second window apart if a force is applied to the first window and/or the second window. A force may be applied by an actuator or by an acceleration force. The acceleration force may result from dropping the optical element.

The motion of the first window and the second window with respect to each other is guided such that a pressure in the sealed volume is constant. Preferably, the pressure in the sealed volume changes at most by 0.1 bar, highly preferred at most 0.01 bar, if a force is applied to the first window or to the second window or to both windows simultaneously. In particular, the solid structure is arranged to define at least one tilting axis of the first or the second window, wherein the tilting axis is aligned such that the pressure in the sealed volume remains constant when tilting the first window and the second window with respect to each other. In particular, the tilting axis extends along an axis of symmetry of the first window and/or the second window seen in a top view along the optical axis. In particular, the tilting axis extends along an interface of the first or second window to the liquid volume.

The optical element described here and in the following is installable into an imaging optical system. The imaging optical system may be integrated into a mobile phone.

Typical modern mobile phones are thin in a direction perpendicular to the plane of the display. Cameras of mobile phones require a long optical path. The optical path between the lens and the imaging sensor exceeds typically the length of the mobile phone perpendicular to the plane of the display. To solve this problem, a folding element is installed in the optical path. The folding element may be arranged to fold the optical path, typically by 90°. Thus, the image sensor may be arranged at an angle, typically 90°, with respect to the first optical surface of the corresponding objective.

Mobile phones are handheld devices which are exposed to vibration, which may result from shaking of the hands. Vibrations can cause unwanted distortion or other optical errors in the image. To solve this problem, the optical element is arranged to compensate vibration optically, by tuning the angle between the first window and the second window. Typically, the optical element comprises two windows enclosing a fluid. An actuator is arranged to control the tilt of the windows, such that the vibrations caused by the shaking of the hands are compensated optically.

A mobile phone is a portable device which is usually carried in bags or trouser pockets. Thus, there is a high risk of the mobile phone being dropped. Dropping the mobile phone causes acceleration forces on the optical elements in the cell phone and thus also on the optical element.

The present optical element is based on the following considerations. Due to the increased pressure in the sealed volume optical elements with a fluid inside are prone to be damaged and to fail. In conventional optical elements the acceleration forces result in an increased pressure in the sealed volume. In a tunable prism the acceleration forces causes the two windows to accelerate towards each other, creating an increased pressure in the liquid volume between them. Due to the increased pressure the membrane and/or the windows experience high stress, which may destroy the optical element eventually.

According to one embodiment, the solid structure forms a first tilting axis. The first tilting axis extends along a first interface of the sealed volume and the first window. Alternatively, the first tilting axis extends along a second interface of the sealed volume and the second window. Here and in the following, the first interface is defined by the area where the first window delimits the sealed volume, or the first interface is defined by the area where the first window is connected extensively to the membrane. Here and in the following, the second interface is defined by the area where the second window delimits the sealed volume, or the second interface is defined by the area where the second window is connected extensively to the membrane.

According to one embodiment, the solid structure forms a second tilting axis. The second tilting axis extends along the first interface or along the second interface. The second tilting axis extends obliquely with respect to the first tilting axis. Preferably, the first tilting axis and the second tilting axis extends perpendicularly with respect to each other. In particular, a tilting motion around the first tilting axis is independently controllable from a tilting motion around the second tilting axis. In particular, the first tilting axis and the second tilting axis may extend along a common interface or along different interfaces.

According to one embodiment, the first tilting axis and/or the second tilting axis extend along an axis of symmetry of the respective first or second interface as seen in a top view on the respective interface. In this context, the top view is a perspective as seen along the optical axis. For example, the first tilting axis extends along the first interface and along an axis of symmetry of the first interface. The second tilting axis may extend along a second interface and along an axis of symmetry of the second interface. Advantageously, tilting the first window and the second window around an axis of symmetry of the respective first or second interface advantageously minimizes changes in the pressure of the sealed volume.

According to one embodiment, the solid structure is arranged within the sealed volume. In particular, the solid structure is arranged in an active region of the optical element. The active region is a portion of the sealed volume through which light passes during intended operation. The solid structure may be absorbent for visible light, so that it may influence the quality of the image. If the solid structure is absorbent, the positioning of the optical element along the optical path of an imaging system is particularly relevant, to minimize imaging defects due to the absorbent solid structure in the optical path.

The solid structure and a fluid may fill the sealed volume completely. The fluid may be transparent for visible light. Hence, absorption or refraction of visible light within the fluid is neglectable.

Alternatively, the solid structure is arranged within the sealed volume and the solid structure is transparent for the visible light. In particular, the solid structure has a refractive index which differs at most by 0.1, preferably at most by 0.01, from a refractive index of the transparent fluid.

According to one embodiment, the solid structure has the shape of a sphere or a pillar. In case, the solid structure has the shape of a sphere, the first window and the second window are in touch with a spherical surface of the solid structure on opposing sides of the solid structure. The first window the second window may form a point contact with the solid structure. In particular, in an undeflected state the point contact is arranged at a point of symmetry of the first window and the second window respectively, as seen in a top view along the optical axis. The tilting axis extends through one of the point contacts along the surface of the respective window, wherein the surface is adjacent to the sealed volume.

In case the solid structure has the shape of a pillar, the solid structure has a spherical surface forming a point contact with the first or the second window. On a side opposed to the point contact, the solid structure is extensively connected to the first or second window. In particular in a non-deflected state, the point contact is arranged at a point of symmetry of the respective window. The tilting axis extends through the point contact along the surface of the respective window, wherein the surface of the window is adjacent to the sealed volume.

A sphere shape of the solid structure enables a tilting axis to be formed between the sphere and the first window as well as between the sphere and the second window. In case the solid structure has the pillar shape the tilting axes are arranged at one of the two windows.

In particular, the solid structure may have the shape of a tetraeder. The solid structure may from a line contact to the first window and to the second window. The line contact of the first window extends perpendicularly with respect to line contact of the second window as seen in a top view along the optical axis. The line contacts extend along one of the tilting axes respectively.

According to one embodiment, the solid structure is arranged outside of the sealed volume, wherein the solid structure has two first contact points to the first window, wherein the first contact points are arranged at an axis of symmetry of the first interface as seen in a top view, and/or the solid structure has two first contact points to the second window, wherein the first contact points are arranged at an axis of symmetry of the second interface as seen in a top view. In particular, the solid structure has two second contact points to the first window or to the second window, wherein the second contact points are arranged at an axis of symmetry of the first interface or second interface respectively.

Preferably, the solid structure is arranged outside of an optically active area of the optical element. For example, the solid structure extends circumferentially around the sealed volume. In particular, the first and the second contact points are arranged on opposite sides of the sealed volume respectively. The sealed volume is completely filled with a transparent fluid, especially a transparent liquid.

According to one embodiment, the solid structure comprises a first solid component and a second solid component. The first solid component and the second solid component are transparent to visible light. The material of the first solid component may differ to the material of the second solid component. Alternatively, the first solid component and the second solid component may be made of the same material as the first window or the second window or both windows.

The first solid component is extensively connected to the first window, whereas the second solid component is extensively connected to the second window. Extensively connected means that the optical transition between the first window and the first solid component as well as between the second window and the second solid component are not disturbed by voids.

The first solid component and the second solid component have a spherical surface, respectively. Both spherical surfaces are in contact with each other. A distance between a first geometric center of the first window and a second geometric center of the second window is independent from the tilt of the first window with reference to the second window and vice versa. As with the other solid structures the pressure in the transparent fluid is independent from the tilt of the first window with respect to the second window.

According to one embodiment, the first window and/or the second window have a planar shape. A planar shape of the first window means that in addition to a planar entrance surface, the opposite side of the first window is also a planar surface that is parallel to the planar entrance surface. A planar shape of the second window means that in addition to a planar exit surface, the opposite side of the first window is also a planar surface that is parallel to the planar exit surface.

According to one embodiment, the optical element comprises an actuator, wherein the actuator is arranged to tilt the first window with respect to the second window. An actuator may comprise multiple actuator modules, wherein the actuator modules are arranged to apply a force the first window or to the second window. In particular, the actuator comprises a first actuator module for tilting the first or second window around the first tilting axis and the actuator comprises a second actuator module for tilting the first or second window around the second tilting axis. In particular, the actuator comprises two first actuator modules, wherein the first actuator modules are arranged on opposite sides of the sealed volume, as seen in a top view along the optical axis. The actuator may comprise two second actuator modules, wherein the second actuator modules are arranged on opposite sides of the sealed volume, as seen in a top view along the optical axis. In particular, the first actuator modules are arranged to tilt the first or the second window in opposite directions, and the second actuator modules are arranged to tilt the first or the second window in opposite directions.

An imaging optical system is also specified. In particular, the imaging optical system comprises an optical element described herein. Hence, all the features disclosed for the optical element are also disclosed for the imaging optical system and vice versa.

The imaging optical system comprises an image sensor, an aperture and the optical element.

The solid structure is absorbent, and the solid structure is arranged in the optically active area, in particular within the sealed volume. The optical element is arranged adjacent to the aperture. Alternatively, the optical element is arranged on a side of the aperture facing away from the image sensor. According to a further alternative, the optical element comprises the aperture. Advantageously, the arrangement of the optical element adjacent to the aperture or on a side of the aperture facing away from the image sensor reduces distortion of the images captured by means of the imaging optical system.

### BRIEF DESCRIPTION OF THE DRAWINGS

Further advantages and applied refinements and developments of the optical element and the imaging optical system emerge from the following exemplary embodiments illustrated in connection with the figures.

FIG. 1 shows an exemplary embodiment of an optical element with a solid structure in form of a spherical shape within the sealed volume.

FIG. 2 shows an exemplary embodiment of an optical element with a solid structure in form of a pillar within the sealed volume.

FIG. 3 shows an exemplary embodiment of an optical element with a solid structure in form of a first solid component and a second solid component within the sealed volume.

FIGS. 4A, 4B, 4C show an exemplary embodiment of an optical element with a solid structure outside the sealed volume.

FIGS. 5A, 5B show an exemplary embodiment of an optical component with a folding element and a solid structure outside the sealed volume.

FIGS. 6A, 6B show an exemplary embodiment of an optical component with a folding element and a solid structure outside the sealed volume.

FIGS. 7A, 7B show an exemplary embodiment of a prism with a folding element and a solid structure outside the sealed volume, wherein one tilting axis extends through the solid structure.

FIGS. 8A, 8B, 8C show an exemplary embodiment of an optical element with a solid structure outside the sealed volume with a guiding structure of a first type.

FIGS. 9A, 9B show an exemplary embodiment of an optical element with a solid structure comprising guiding structure of a second type.

FIG. 10 shows an exemplary of an optical element in a schematic side view.

FIG. 11 shows a detail view of an exemplary embodiment of a coil assembly of an optical element shown in FIG. 10.

Identical, similar or identically acting elements are provided with the same reference symbols in the figures. The figures and the proportions of the elements shown in the figures among one another are not to be considered to scale, unless units are expressly stated. Rather, individual elements can be shown in an exaggerated size for better representation and/or for better comprehensibility.

### DETAILED DESCRIPTION

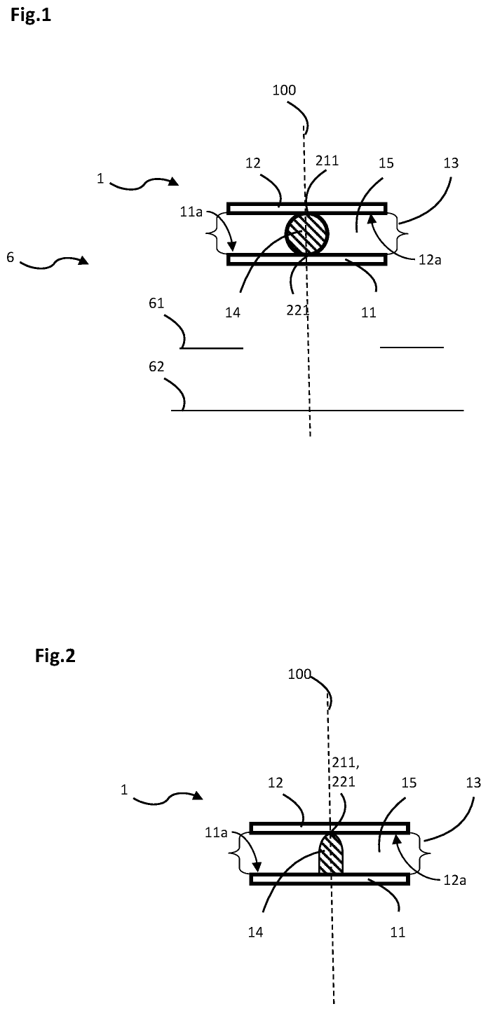

FIG. 1 shows an exemplary embodiment of an optical element 1 in a schematic sectional view, comprising a sealed volume 15, a first window 11, a second window 12 and a membrane 13. The membrane 13 encloses the sealed volume 15 in lateral directions. In one of the directions perpendicular to lateral directions the sealed volume 15 is delimited by the first window 11, whereas in an opposite direction the sealed volume 15 is delimited by the second window 12. In the embodiment of FIG. 1, the first window and the second window delimit the sealed volume on opposite sides along an optical axis 100. Alternatively, the membrane 13 may enclose the entire sealed volume 15, meaning the membrane 13 encloses the sealed volume 15 in lateral directions and in directions perpendicular to lateral directions. Thus, according to the alternative the first window and the second window are attached extensively to the membrane 13.

In particular, in case the membrane encloses the sealed volume completely on all sides, the first window and the second window are arranged to stiffen the membrane 13 at a first interface 11a and at a second interface 12a.

A solid structure 14 is arranged within the sealed volume 15. The solid structure 14 in FIG. 1 has a spherical shape and spaces the first window 11 from the second window 12. The solid structure 14 contacts the first interface 11a and the second interface 12a.

The first window 11 as well as the second window 12 are tiltable. Each window 11, 12 can be tilted separately by an actuator. The actuator is not shown in FIG. 1. The first tilting axis 211 of the first window 11 extends through a first plane parallel to the main extension plane of the first window 11, whereas the tilting axis of the second window 12 extends through a first plane parallel to the main extension plane of the second window 12. In FIG. 1 the first plane parallel to the main extension plane of the first window 11 and the first plane parallel to the main extension plane of the second window 12 are each a tangential plane to the spherical shaped solid structure 14. The first tilting axis 211 of the first window 11 extends through the point of contact between the spherical shaped solid structure 14 and the first window 11, whereas the second tilting axis 212 of the second window 12 extends through the point of contact between the spherical shaped solid structure 14 and the second window 12. Both tilting axes 211, 212 are arranged such that the first tilting axis 211 of the first window 11 is perpendicular to the second tilting axis 212 of the second window 12. In particular, the direction of the first tilting axis and the second tilting axes are defined by the actuator moving the first window and the second window with respect to each other.

The sealed volume is deformed by tilting the first window 11 or by tilting the second window 12 or by tilting both windows 11, 12 simultaneously. However, tilting the first window 11 or tilting the second window 12 or tilting both windows 11, 12 simultaneously does not change a pressure in the sealed volume 15. In particular, the spherical shaped solid structure 14 is arranged to guide the tilting movement of the first window 11 with respect to the second window 12 or the tilting movement of the second window 12 with respect to the first window 11 or the tilting movements of both windows 11, 12 at the same time. The guidance is arranged to maintain the pressure in the sealed volume constant while tilting the first and the second window with respect to each other.

Further, the pressure in the sealed volume 15 stays constant when an external force is applied to the first window 11 or to the second window 12 or to both windows 11, 12 at the same time. In particular, the pressure remains essentially constant, when acceleration forces act on the optical element. This is the case, for example, when dropping a mobile phone in which an optical element 1 is installed. The spherically shaped solid structure 14 reduces the risk of damaging the membrane 13 or the first or second window. In particular, the pressure in the sealed volume 15 changes at most by 0.1 bar.

The sealed volume 15 is filled with a transparent fluid, which can be gaseous or liquid.

For example, in FIG. 1 the spherically shaped solid structure 14 may be absorbent to visible light and the solid structure 14 is arranged within the sealed volume 15. The spherically shaped solid structure 14 is arranged in the optically active region of the optical element 1. The optical element 1 may be arranged in the optical path of an imaging optical system 6, wherein the spherical shaped solid structure 14 blocks part of the light in the optical path. In order to minimize the obscuration of the optical image, the optical element 1 is arranged adjacent to an aperture of the imaging optical system 6. Alternatively, the optical element 1 may be arranged on a side of the aperture 61 facing away from an image sensor 62 of the imaging optical system 6. In another alternative, the prism 5 with the optical element 1 comprises the aperture 61 itself. Alternatively, the spherical shaped solid structure 14 is arranged within the sealed volume 15, but not in the active region of the optical element 1. Here, the prism 5 with the optical element 1 is arranged in a suitable region of the optical path of the imaging optical system 6.

The fluid of the sealed volume 15 is transparent to visible light. Alternatively, the spherical shaped solid structure 14 is transparent to visible light and has a refractive index that differs at most by 0.1, preferably at most by 0.01, from a refractive index of the transparent fluid.

The first window 11 and the second window 12 in FIG. 1 have a planar shape, respectively.

FIG. 2 shows an exemplary embodiment of an optical element 1 with a solid structure 14 within the sealed volume 15 in a schematic sectional view. FIG. 2 shows an optical element 1 according to the invention comprising a sealed volume 15, a first window 11, a second window 12 and a membrane 13. As in FIG. 1 the membrane 13 encloses the sealed volume 15 in lateral directions, whereas the first window 11 and the second window 12 enclose the sealed volume 15 along the optical axis 100.

The solid structure 14 within the sealed volume 15 is pillar-shaped. Like the spherical shaped solid structure 14 of FIG. 1 the pillar shaped solid structure 14 of FIG. 2 spaces the first window 11 and the second window 12 apart. In FIG. 2 the first and the second tilting axis are formed at the second interface 12a between the solid structure 14 and the second window 12. At the second interface 12a, the second window 12 delimits the sealed volume 15 and at a first interface 11a the first window 11 delimits the sealed volume 15.

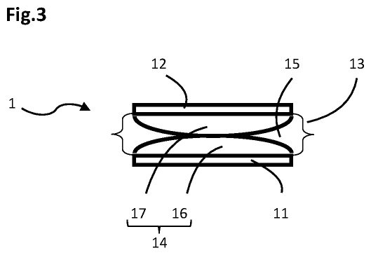

FIG. 3 shows an exemplary embodiment of an optical element 1 with a solid structure 14 within the sealed volume 15. FIG. 3 shows an optical element 1 comprising a sealed volume 15, a first window 11, a second window 12 and a membrane 13. As in FIG. 1 the membrane 13 encloses the sealed volume 15 in lateral directions, whereas the first window 11 and the second window 12 enclose the sealed volume 15 in one of the directions perpendicular to lateral directions respectively.

The solid structure 14 comprises a first solid component 16 and a second solid component 17. The first solid component 16 is extensively connected to the first window 11, whereas the second solid component 17 is extensively connected to the second window 12. The first solid component 16 and the second solid component 17 have each a spherical surface. The spherical surfaces of the components 16, 17 are in contact with each other.

The first window 11 and the second window 12 are tiltable with respect to each other. When tilting the first window and the second window with respect to each other, the spherical surfaces roll off on each other or glide on each other. A distance between a first geometric center of the first window 11 and a second geometric center of the second window 12 is independent from the tilt of the first window 11 with respect to the second window 12 and vice versa.

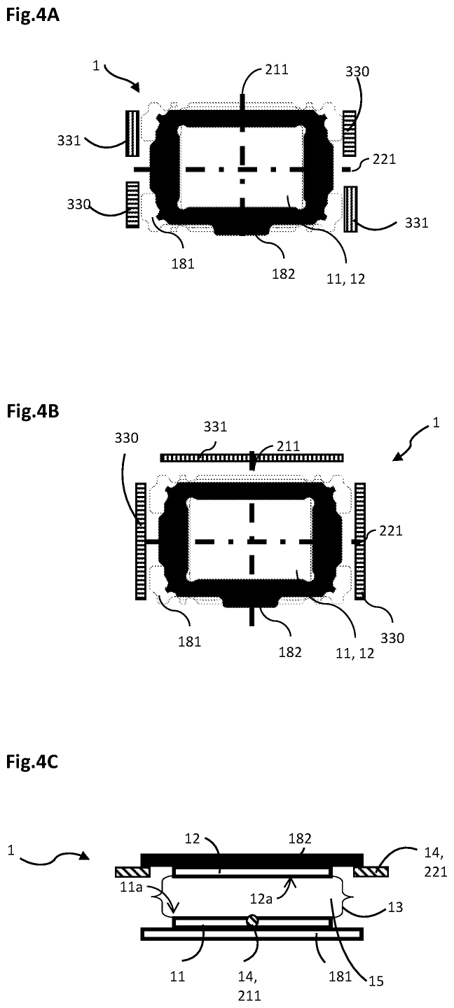

FIG. 4A shows an exemplary embodiment of an optical element 1 with an actuator 33 in a schematic top view along the optical axis 100. The optical element 1 comprises a first shaper 181 and a second shaper 182. The first shaper 181 is fixedly attached to the first window 11 and the second shaper 182 is fixedly attached to the second window 12. The first window 11 is tiltable around a first tilting axis 211 and the second window 12 is tiltable around a second tilting axis 221.

The first shaper 181 and the second shaper 182 have an opening, through which light in the visible wavelength range may pass into the sealed volume. In particular, the first shaper and or the second shaper may be absorbent. For example, the first shaper or the second shaper acts as an aperture of an optical imaging system 6

The actuator 33 is arranged to tilt the first 11 and second 12 window around their respective tilting axis 181, 182. The actuator comprises multiple actuator modules of a first type 330 and multiple actuator modules of a second type 331. The actuator modules of the first kind 330 are arranged to tilt the first shaper 181 and the first window 11 around the first tilting axis 211. The second actuator modules are arranged to tilt the second shaper 182 and the second window 12 around the second tilting axis 221. The actuator modules of a same type are arranged diagonally on opposing sides of the sealed volume 15. In particular, the actuator modules of a same type are arranged on opposing sides of the tilting axis 181, 182 around which the respective actuator type tilts the first 11 or second 12 window respectively.

FIG. 4B shows an exemplary embodiment of an optical element 1 in a schematic top view along the optical axis. The embodiment shown in FIG. 4B differs from the embodiment shown in FIG. 4a in the arrangement of actuator modules of the first type 331 and the second type 330. The actuator 33 comprises two actuator modules of the first type 330 which are arranged on opposing sides of the sealed volume 15 as seen in a top view. The actuator 33 comprises a single actuator module of the second type 331.

FIG. 4C shows an exemplary embodiment of an optical element 1 in a schematic side view. The optical element 1 comprises a sealed volume 15, a first window 11, a second window 12 and a membrane 13. As in FIG. 1 the membrane 13 encloses the sealed volume 15 in lateral directions, whereas the first window 11 and the second window 12 enclose the sealed volume 15 in one of the directions perpendicular to lateral directions.

In contrast to FIGS. 1 to 3 the optical element 1 of FIG. 4C comprises a solid structure 14, which is arranged outside the sealed volume 15. The solid structure 14 comprises pins wherein two pins extend along each tilting axis 211, 221 respectively. The two pins which are assigned to a common tilting axis 211, 221 are arranged on opposite sides of the sealed volume 15. The pins may be part of s sliding bearing. The first window 11 as well as the second window 12 are both arranged tiltable. The first tilting axis 211 of the first window 11 extends along the main extension plane of the first window 11, whereas the first tilting axis 221 of the second window 12 extends along the main extension plane of the second window 12. Both tilting axes 211, 221 are perpendicular to each other. In particular, the first tilting axis 211 extends within the first interface 11a and the second tilting axis 221 extends along the second interface 12a.

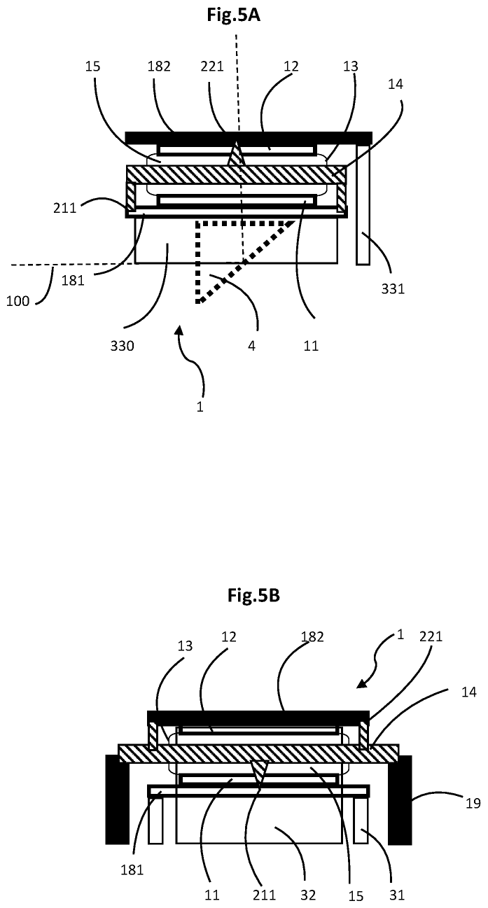

FIG. 5A shows an exemplary embodiment of an optical element 1 in a schematic side view. The optical element 1 comprises a sealed volume 15, a first window 11, a second window 12 and a membrane 13. The membrane 13 encloses the sealed volume 15 in lateral directions, whereas the first window 11 and the second window 12 enclose the sealed volume 15 in one of the directions perpendicular to lateral directions.

In contrast to FIGS. 1 to 3 the optical element 1 of FIG. 5A comprises a solid structure 14, which is arranged outside the sealed volume 15. In FIG. 5A the solid structure 14 has a frame shape, which spaces the first window 11 and the second window 12 apart. The solid structure extends circumferentially around the sealed volume 15. Dedicated contact points of the solid structure 14 to the first shaper 181 and the second shaper 182 determine the first tilting axis 181 and the second tilting axis 182. In particular, the solid structure 14 and the first shaper 181 have two point contacts or two line contacts which are arranged on the first tilting axis 211. In particular, the solid structure 14 and the second shaper 182 have two point contacts or two line contacts which are arranged on the second tilting axis 221.

The first window 11 as well as the second window 12 are tiltable. The first window 11 and the second window 12 can be tilted individually. The first window 11 is tilted by the actuator module of the first type 330, and the second window 12 is tilted by the actuator module of the second type 331.

The optical component comprises a folding element 4, which is arranged to fold the optical path 100 by 90°. The folding element may be a prism or a mirror.

The optical element 1 of FIG. 5A comprises further a first shaper 181 and a second shaper 182. The first window 11 is attached to the first shaper 181, whereas the second window 12 is attached to the second shaper 182. During intended operation of the optical element 1, the first shaper 181 and the second shaper 182 do not interact with visible light passing through the sealed volume. In FIG. 5A, the first shaper 181 and the second shaper 182 each have an opening through which light may pass.

FIG. 5B shows an exemplary embodiment of an optical element 1 in a schematic side view. The optical element 1 comprises a support module 19. The support module is attached to the solid structure 14 and defined a position of the solid structure 14. The first window 11 and the second window 12 are tiltable with respect to the solid structure 14. In particular, the position of the solid structure is independent from the tilt of the first window 11 and the second window 12.

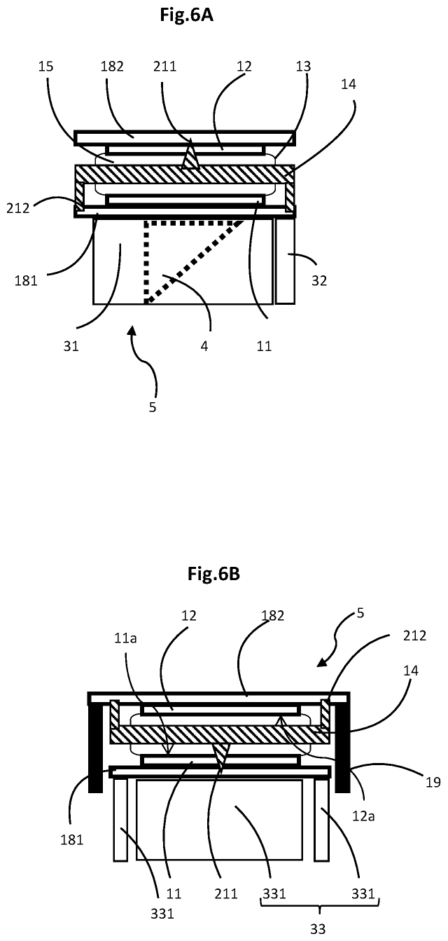

FIGS. 6A and 6B show an exemplary embodiment of an optical element in schematic side views. The optical element 1 comprises a sealed volume 15, a first window 11, a second window 12 and a membrane 13. The membrane 13 encloses the sealed volume 15 in lateral directions, whereas the first window 11 and the second window 12 enclose the sealed volume 15 in one of the directions perpendicular to lateral directions.

The optical element 1 comprises a solid structure 14, which is arranged outside the sealed volume 15. The solid structure 14 has the shape of a frame, which spaces the first window 11 and the second window 12 apart.

In contrast to the embodiment shown in FIG. 5A, in the embodiment of FIG. 6A the actuator 33 is attached solely to the first window 11. The actuator 33 comprises an actuator assembly of the first type 330 and actuator assemblies of the second type 331. The actuator assembly of the first type 331 is arranged to tilt the first window 11 around the first tilting axis 211, wherein the first tilting axis extends along the first interface 11a. The actuator assembly of the second type 331 is arranged to tilt the first window 11 with respect to the second window 12 around the second tilting axis 212. The second tilting axis 212 extends along the second interface 12a. The support module 19 is attached to the second window 12 and defines the position of the second window 12. For the sake of simplicity, the support module 19 is not shown in FIG. 6A. Both tilting axes 211, 212 are arranged perpendicular to each other.

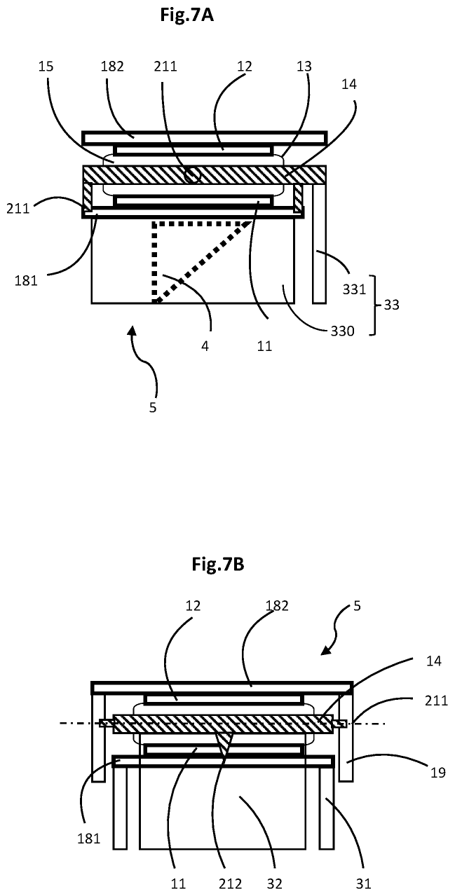

FIGS. 7A and 7B show an exemplary embodiment of an optical element in schematic side views. The optical element 1 comprises a solid structure 14, which is arranged outside the sealed volume 15. The solid structure 14 has a frame shape, which spaces the first window 11 and the second window 12 apart.

the first window 11 is tiltable with respect to the second window 12. The second window 12 is attached to the support module 19. For the sake of simplicity, the support module 19 is not shown in FIG. 7A. The first window 11 is tiltable around the first tilting axis 181 and around the second tilting axis 181 with respect to the second window 12. The actuator assembly of the first type 330 is arranged to tilt the first window 11 around the first tilting axis 211. The actuator assembly of the second type 331 is arranged to tilt the first window 11 around the second tilting axis 212. The first tilting axis extends along the first interface 11a. the second window 12 extends through the sealed volume 15 parallel to the first interface 11a and obliquely with respect to the first tilting axis 211.

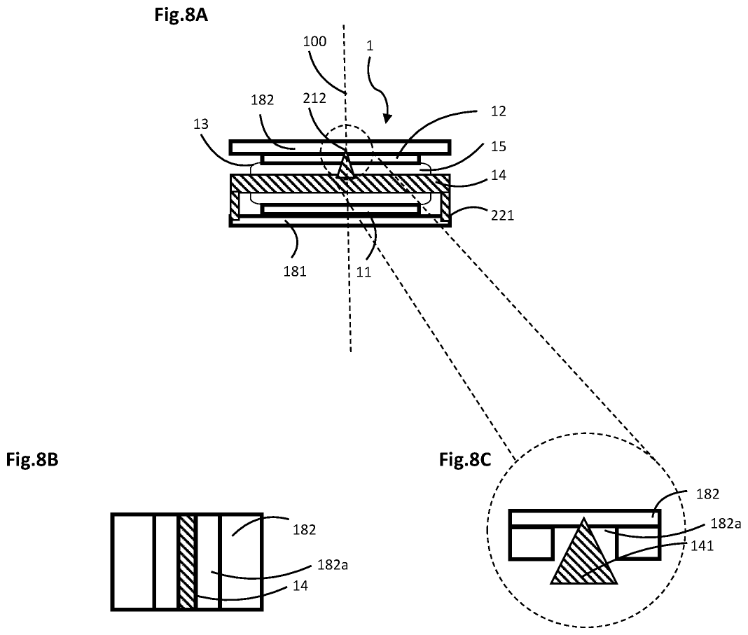

FIG. 8A shows an exemplary embodiment of an optical element 1 in a schematic side view. The FIGS. 8C and 8C show the interface between the solid structure 14 and the first and/or second shaper 181, 182 in a more detailed view. FIG. 8A shows a schematic sideview of the detail marked by the dashed circle in FIG. 8A. FIG. 8C shows the detail in a schematic top view along the optical axis 100.

The solid structure 14 comprises a tip 141, which is in touch with the second shaper 182. The mechanical contact of the second shaper 182 and the tip 141 defines the second tilting axis. The second shaper 182 comprises a recess 182a in which the tip 141 is arranged. The recess 182a provides a mechanical hard stop. The hard stop reduces the risk of the second shaper 182 slipping with respect to the solid structure 14 when tilting the second shaper 182. In particular, the interface of the solid structure 14 and the first shaper 181 may have a similar structure. The recess has elongated shape extending along the respective tilting axis 211, 212. As shown in FIG. 8C, the tip 141 has an elongated shape. Thus, the solid structure 14 and the first and/or second shape form a line contact to each other

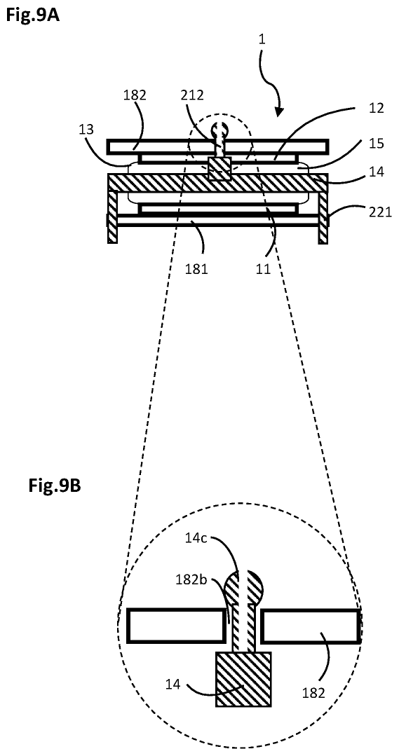

FIG. 9A shows the exemplary embodiment of an optical element in a schematic side view. FIG. 9B shows a detailed view of the interface between the solid structure 14 and the second frame 182 marked by a dashed circle in FIG. 9A. The solid structure 14 and the second shaper 182 are connected in a form fitting manner by means of a clip connection. The second shaper 182 comprises a though hole 182b and the solid structure 14 comprises a clipping pin 14c. The clipping pin 14c is inserted into the through hole 182b, wherein the clipping pin is compressed. The clipping pin 14c and the through hole 182b are connected form fittingly. Advantageously, the form fitting connection between the solid structure 14 and the second shaper 182 prevents the second shaper 182 from losing contact to the solid structure 14 under exposure to acceleration forces. In particular, the solid structure 14 may be connected to the first shaper 181 in a similar manner. Advantageously the clipping connection prevents and increase of a distance between the first window 11 and the second window 12 along the optical axis 100.

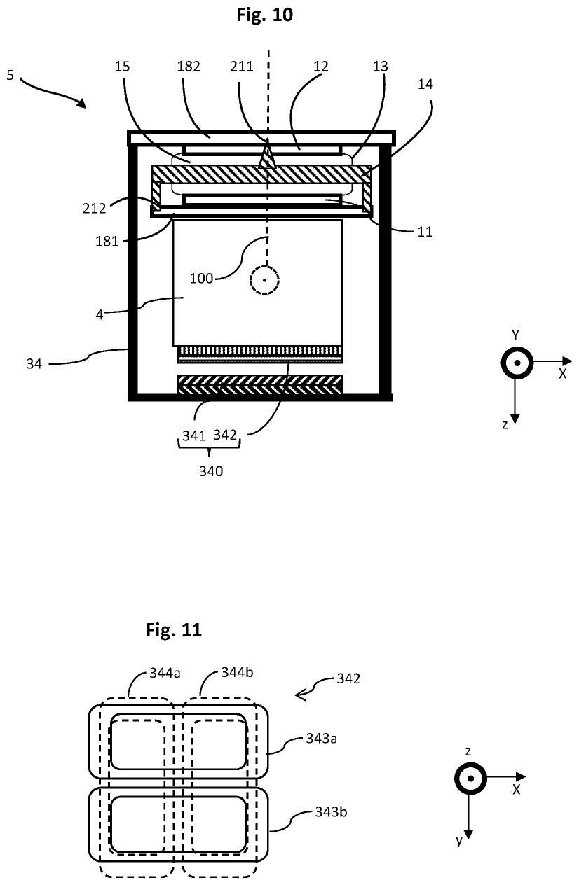

FIG. 10 shows an exemplary of an optical element 1 in a schematic side view. The first shaper 181 fixedly attached to the folding element 4. The folding element 4 is arranged to fold the optical axis 100 by 90°. The optical axis 100 extends along the z-axis before being deflected by the folding element 4 and the optical axis extends along the y-axis after being deflected by the folding element 4, or vice versa. The second shaper 182 is fixedly attached to a cage 34. The cage extends in the X-Z-plane in a frame-like manner around the folding element 4.

An actuator assembly 340 is arranged to control the deflection of the cage 34, which alters the tilt between the first shaper 181 and the second shaper 182. The actuator assembly 340 is arranged on a side of the folding element 4 which is opposed to the prism 5. The actuator assembly 340 comprises a coil assembly 342 and a magnet assembly 341. As illustrated by the hatching, the magnet assembly 341 is magnetized along the Z-axis.

FIG. 11 shows a detail view of an exemplary embodiment of a coil assembly 342 as seen in a top view along the z-axis. The coil assembly comprises coils of a first type 343a, 343b and coils of a second type 344a, 344b. The coils of the first type 343a, 343b are arranged in a common plane, which extends along the x-y-plane, and the coils of the second type 344a, 344b are arranged in a common plane, which extends along the x-y-plane. The coil windings of all coils are wound around a winding axis respectively. Wherein the winding axis extends along the z-axis. During operation, the current in the coils of the first type 343a, 343b runs in opposing directions, which causes a deflection of the magnet assembly 341 along the x-axis. During operation, the current in the coils of the second type 344a, 344b runs in opposing directions, which causes a deflection of the magnet assembly 341 along the y-axis.

### LIST OF REFERENCE SIGNS

1 optical element
11 first window
11a first interface
12 second window
12a second interface
13 membrane
14 solid structure
14c clipping pin
15 sealed volume
16 first solid component
17 second solid component
100 optical axis
181 first shaper
181a recess in first shaper
181b through hole in first shaper
182 second shaper
182a recess in second shaper
182b through hole in second shaper
19 support module
211 first tilting axis of the first window
212 second tilting axis of the first window
230 spherical surface
33 actuator modules
330 actuator assembly of a first type
331 actuator assembly of a second type
34 cage
340 actuator assembly
341 magnet assembly
342 coil assembly
343a, 343b coils of a first kind
344b, 344b coils of a second kind
4 folding element
5 prism
6 optical system
61 aperture
62 image sensor
X x-axis
Y y-axis
Z z-axis

We claim:

1. Optical element comprising a sealed volume, a first window, a second window and a membrane,
wherein the membrane encloses the sealed volume in lateral directions and the membrane encloses the sealed volume in directions perpendicular to lateral directions, or the first window and the second window enclose the sealed volume in directions perpendicular to lateral directions,
wherein the sealed volume is deformable by tilting the first window with respect to the second window,
wherein the first window and the second window are spaced apart by a solid structure, and the solid structure is arranged to guide a motion of the first window with respect to the second window, so that a pressure in the sealed volume is constant.

2. Optical element according to claim 1, wherein the solid structure forms a first tilting axis, the first titling axis extends along a first interface of the sealed volume and the first window, or the first tilting axis extends along a second interface of the sealed volume and the second window.

3. Optical element according to claim 2, wherein the solid structure forms a second tilting axis, the second tilting axis extends along the first interface or along the second interface, wherein the second tilting axis extends obliquely with respect to the first tilting axis.

4. Optical element according to claim 2, wherein the first tilting axis and/or the second tilting axis extend along an axis of symmetry of the respective first or second interface as seen in a top view on the respective interface.

5. Optical element according to claim 1, wherein the solid structure is arranged within the sealed volume,
wherein the sealed volume is filled with a fluid that is transparent for visible light,
wherein the solid structure is absorbent to visible light or the solid structure is transparent and has a refractive index which differs at most by 0.1, preferably at most by 0.01, from a refractive index of the transparent fluid.

6. Optical element according to claim 5, wherein the solid structure has the shape of a sphere or a pillar.

7. Optical element according to claim 4, wherein the solid structure comprises a first solid component extensively connected to the first window and a second solid component extensively connected to the second window,
wherein the first solid component and the second solid component are transparent for visible light,
wherein the first solid component and the second solid component have a spherical surface respectively, and both spherical surfaces are in contact with each other.

8. Optical element according to claim 1, wherein the solid structure is arranged outside of the sealed volume,
the solid structure has two first contact points to the first window, wherein the first contact points are arranged at an axis of symmetry of the first interface as seen in a top view and/or
the solid structure has two first contact points to the second window, wherein the first contact points are arranged at an axis of symmetry of the second interface as seen in a top view.

9. Optical element according to claim 1 comprising an assembly of actuator modules, wherein the actuator modules are arranged to tilt the first window with respect to the second window.

10. An imaging optical system comprising an image sensor, an aperture and an optical element according to claim 5,
wherein the solid structure is absorbent,
wherein the optical element is arranged adjacent to the aperture or the optical element comprises the aperture, or the optical element is arranged on a side of the aperture facing away from the image sensor.
